(19) United States
(12) Patent Application Publication
(10) Pub. No.: US 2017/0053788 A1
(43) Pub. Date: Feb. 23, 2017

(54) PAPER CONE TIP, AND PAPER CONE SPRAY IONIZATION MASS SPECTROMETRY USING THE SAME

(71) Applicant: HANKUK UNIVERSITY OF FOREIGN STUDIES RESEARCH & BUSINESS FOUNDATION, Yongin-si (KR)

(72) Inventors: Sangwon Cha, Yongin-si (KR); Purum Kim, Yongin-si (KR)

(21) Appl. No.: 15/091,226

(22) Filed: Apr. 5, 2016

(30) Foreign Application Priority Data
Aug. 18, 2015 (KR) 10-2015-0116233

(51) Int. Cl. H01J 49/16; H01J 49/00

(52) U.S. Cl. CPC H01J 49/167; H01J 49/0027

(57) ABSTRACT

A paper cone tip, having a triangular-pyramidal shape with a vertex angle of 12.5° to 45°, and to a paper cone spray ionization mass spectrometry (PCSI MS) method using a paper cone tip, including: preparing the paper cone tip having a triangular-pyramidal shape; placing a measuring sample in the paper cone tip and locating the paper cone tip in front of a mass spectrometer; and adding a spraying solvent to the paper cone tip and applying a voltage thereto. The paper cone tip having a triangular-pyramidal shape is suitable for use in PCSI MS for the direct analysis of solid samples of raw materials, and the three-dimensional paper cone tip serves as a sample container, a solid-liquid extraction chamber, an analyte transport channel, and an electrospray tip.

### RELATED APPLICATIONS

This application claims priority under 35 U.S.C. §119 to Korean Patent Application No. 10-2015-0116233, filed Aug. 13, 2015. The entire teachings of the above application are incorporated herein by reference.

### BACKGROUND OF THE INVENTION

1. Field of the Invention

The present invention relates to a paper cone tip and paper cone spray ionization mass spectrometry using the same. More particularly, the present invention relates to a three dimensional paper cone tip, and to a paper cone spray ionization mass spectrometry method, which may exhibit superior extraction effects in various solid materials using the paper cone tip.

2. Description of the Related Art

Paper spay ionization (PSI) is an ambient extractive ionization method used in mass spectrometry. PSI typically utilizes a planar piece of triangular-shaped paper as a sampling base, in addition to an electrospray tip.

In PSI, a liquid sample is usually applied and dried on a paper base. However, fresh liquid samples or thin tissue specimens are also successfully analyzed using PSI mass spectrometry (MS). Dried analytes, as a solid-state sample, are extracted and transported towards the sharp edge of a paper base using a spraying solvent. The transfer of analytes through a paper base is known to be due to a combination of three processes: capillary action, electrophoretic migration, and bulk liquid transportation. Analytes are effectively sprayed and ionized through processes such as electrospray ionization, which are mainly affected by the polarity and volume of the solvent remaining on the paper tip.

The properties of the spraying solvent and the paper base are the most important parameters in PSI. Alcoholic solvents are frequently used in PSI MS. Also, nonpolar solvents such as hexane are compatible with PSI MS, and are efficiently employed in the analysis of nonpolar analytes such as hydrocarbons. The most common paper materials in PSI MS are filter or chromatography papers, owing to their excellent wetting properties and low chemical backgrounds. In specific applications, alternative paper materials or chemically modified paper bases exhibit unique advantages over conventional PSI substrates. For example, in the analysis of dried blood spots (DRS) with PSI MS, silica-coated paper showed sample recovery and sensitivity superior to those of conventional chromatography paper. Printing paper is advantageous in the analysis of nicotine metabolites from liquid blood samples. PSI MS using paper coated with carbon nanotubes (CNT) generates signals from simple organic molecules with a substantially low voltage (˜3 V). In addition, CNT-paper-based PSI MS can directly extract and detect intact proteins entrapped in a gel piece.

PSI ME has been employed in various applications, and its most active application is the qualitative and quantitative drug analysis of DBS. Other applications include the analysis of blood contaminants, herbal products, inorganic materials, noncovalent protein complexes, ballpoint pen inks, and pesticides.

Recently, PSI MS coupled with microdroplet-generating fluidics has been utilized for monitoring cell culture chemicals and for quantifying protein-protein interactions.

Additional background information regarding paper spray mass spectrometry may be found in the following articles:

Y. Ren, H. Wang, J. Liu, Z. Zhang, M. McLuckey, and Z. Ouyang. (2013). “Analysis of Biological Samples Using Paper Spray Mass Spectrometry: An Investigation of Impacts by the Substrates, Solvents and Elution Methods”, Chromatographia, 76(19-20), pp. 1339-1346.

Z. Zhang, W. Xu, N. E. Manicke, B. G. Cooks, and Z. Ouyang. (2012). “Silica Coated Paper Substrate for Paper-Spray Analysis of Therapeutic Drugs in Dried Blood Spots”. Anal. Chem., 84(2), pp. 931-938.

### SUMMARY OF THE INVENTION

Accordingly, an object of the present invention is to provide a paper cone tip having an improved structure, suitable for use in a paper spay ionization method.

Another object of the present invention is to provide a paper cone spray ionization mass spectrometry method, which exhibits superior extraction effects in various solid materials using the paper cone tip having the improved structure.

The present invention provides a paper cone tip, having a triangular-pyramidal shape with a vertex angle of 12.5° to 45°.

The paper cone tip is preferably formed by folding a circular-sector-shaped paper into quarters.

The paper cone tip may have a volume of 19.5 microliters (μL) to 303 μL.

The paper is preferably a weighing paper.

The paper cone tip is preferably transparent.

In addition, the present invention provides a paper cone spray ionization mass spectrometry method using a paper cone tip, comprising: preparing the paper cone tip having a triangular-pyramidal shape, placing a measuring sample in the paper cone tip and locating the paper cone tip in front of a mass spectrometer, and adding a spraying solvent to the paper cone tip and applying a voltage thereto.

The spraying solvent is preferably an alcoholic solvent.

The paper cone tip may serve as a sample container, an extraction chamber, a transport channel for an extracted analyte, and an electrospray tip.

Useful for extraction, the measuring sample may include various solid materials including powdered drugs and food materials.

The voltage may be a high voltage of ±3 kilovolts (kV) to 4 kV.

According to the present invention, the paper cone tip having a triangular-pyramidal shape is suitable for use in paper cone spray ionization (PCSI) mass spectrometry for directly analyzing solid samples of raw materials.

According to the present invention, the three-dimensional paper cone tip serves as a sample container, a solid-liquid extraction chamber, an analyte transport channel, and an electrospray tip.

Thus, when such a paper cone tip is utilized in PCSI MS, major chemical fingerprints can be rapidly produced from various solid materials including powdered tablets as well as raw and processed food materials.

The above and other features of the invention including various novel details of construction and combinations of parts, and other advantages, will now be more particularly described with reference to the accompanying drawings and pointed out in the claims. It will be understood that the particular product and process embodying the invention are shown by way of illustration and not as a limitation of the invention. The principles and features of this invention may be employed in various and numerous embodiments without departing from the scope of the invention.

### BRIEF DESCRIPTION OF THE DRAWINGS

The above and other objects, features and advantages of the present invention will be more clearly understood from the following detailed description taken in conjunction with the accompanying drawings, in which:

FIGS. 1A to 1C schematically illustrate the process of preparing a paper core tip according to the present invention and the PCSI MS using the same;

FIGS. 2A and 2B illustrate extracted ion chronograms for [PC 34:1+Na]⁺ ions at m/z 798.8, measured from 5.0 mg of a ground beef sample using a weighing paper cone tip and a filter paper cone tip, respectively;

FIGS. 3A to 3F illustrate the results of PCSI MS of various powdered tablets: Diazepam (an anxiolytic) (FIG. 3A), Stilnox (a hypnotic drug) (FIG. 3B), Zantac 75 (an antacid) (FIG. 3C), Claritin (an antihistamine) (FIG. 3D), Norvasc (a calcium channel blocker) (FIG. 3E), and Crestor (a cholesterol-lowering drug) (FIG. 3F), along with the chemical structures of active components thereof;

FIGS. 4A to 4F illustrate the tandem mass spectra results of the main active components of FIGS. 3A to 3F;

FIGS. 5A and 5B illustrate the PCSI MS results of powdered digestive drugs;

FIG. 6 illustrates the ion chronogram for [zolpidem+H]⁺ ions measured after repeated extraction from 1.0 mg of a powdered Stilnox tablet through PCSI MS;

FIGS. 7A to 7C illustrate the PCSI MS results of various solid samples, including 1.0 mg of green tea leaves (FIG. 7A), 1.0 mg of infant formula (FIG. 7B), and 5.0 mg of ground beef (FIG. 7C), in which the spraying solvent is methanol in FIGS. 7A, 7B, and 7C-i, ethanol in FIG. 7C-ii, isopropanol in FIG. 7C-iii, and ethanol containing 5 mM ammonium acetate (NH₄OAc) in FIG. 7C-iv; and

FIG. 8 illustrates the representative tandem mass spectra for [PC 34:1+Na]⁺ ions at m/z 783 and [TAG 52:2+Na]⁺ ions at m/z 832.

### DESCRIPTION OF SPECIFIC EMBODIMENTS

Hereinafter, a detailed description will be given of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprise”, “include”, “have”, etc. when used in this specification, specify the presence of stated shapes, integers, steps, operations, members, elements, and/or combinations thereof, but do not preclude the presence or addition of one or more other shapes, integers, operations, members, elements, and/or combinations thereof.

The present invention pertains to a paper cone tip having an improved structure, which is used as a paper base in a paper cone spray ionization mass spectrometry method, and to a paper cone spray ionization mass spectrometry method using the same.

According to the present invention, PSI MS is applicable to direct raw material analysis by modifying the shape of the paper tip from a planar triangle into a three-dimensional cone.

In the method named as “paper cone spray ionization mass spectrometry” (hereinafter, abbreviated as “PCSI MS”) according to the present invention, the shape and state of a sample are not particularly limited, so long as the sample fits into a paper cone. This is because the paper base itself is not involved in the extraction process. Instead, a semipermeable paper cone tip according to the present invention in PCSI MS acts as a sample container, an extraction chamber, a transport channel for extracted analytes, and an electrospray tip.

The paper cone tip according to the present invention has a triangular-pyramidal shape with a vertex angle ranging from 12.5° to 45°, wherein the vertex angle may vary depending on the kind of sample to be extracted. If the vertex angle is less than 12.5°, the volume of the loaded sample is decreased, making it difficult to implement PCSI MS.

The paper cone tip is preferably manufactured by folding a circular-sector-shaped paper into quarters. Preferably useful as the circular-sector-shaped paper is a quadrant with a radius of 1 centimeter (cm) to 2 cm.

The volume of the paper cone tip thus manufactured may be is in the range of 19.5 microliters (μL) to 303 μL.

In the present invention, based on the results of testing of various paper candidates, a weighing paper was selected as the best substrate, based on its characteristics.

Also, the weighing paper, which is the paper cone tip according to the present invention, is transparent, which allows the amount of a solid sample that is loaded into the paper cone tip to be monitored.

Initially, a circular-cone-shaped paper tip was manufactured by rolling paper. However, when using this tip, spray ionization was not stable, and samples were prone to leak during MS analysis because the circular cone tip easily became unrolled after applying the sample and the solvent.

However, the triangular-pyramidal-shaped paper cone tip according to the present invention does not have the above problems. Furthermore, a pyramidal paper tip with a narrower or larger vertex angle may be manufactured, and this geometrical change may affect the ionization efficiency.

For example, similar to conventional PSI, a paper cone tip having a smaller vertex angle (e.g., 15°) requires a lower onset voltage. However, as the vertex angle decreases, the sample loading volume also decreases. Further, investigation of the geometry of the paper cone tip needs to optimize the sample loading capacity, the ionization efficiency, and the sensitivity of PCSI MS.

As thoroughly investigated in previous PSI MS studies, the properties of paper substrates, such as wettability, porosity, and surface hydrophobicity, are the most important experimental parameters. Therefore, in the present invention, various types papers, including filter paper, or chromatography paper, printing paper, and weighing paper for PCSI MS, were tested. Among the paper materials tested, weighing paper is regarded as the best substrate for PCSI MS for the following reasons.

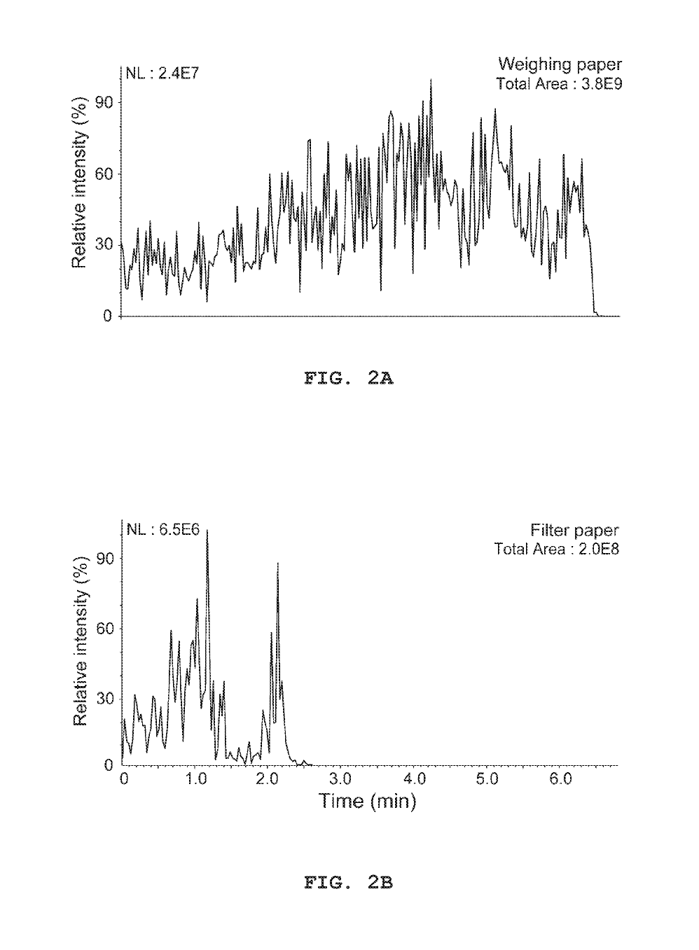

First, a weighing paper cone can retain the spraying solvent much longer than other paper materials due to its low solvent permeability. The longer retention time is effective at solid-liquid extraction between a raw solid sample and a spraying solvent. When the filter or chromatography paper is used as a paper cone substrate, rapid permeation of the solvent into the paper cone leaves little time to interact with a loaded solid sample (FIGS. 2A and 2B).

FIGS. 2A and 2B illustrate the extracted ion chronograms for [PC 34:1+Na]⁺ ions at m/z 798.8, as measured from 5.0 mg of a ground beef sample using the weighing paper cone tip (FIG. 2A) and the filter paper cone tip (FIG. 2B). The spraying solvent that was used was 50 μL of ethanol. As illustrated in FIGS. 2A and 2B, when using the weighing paper cone tip, more stable and higher analytical signals were observed for a longer period of time. Consequently, the total ion count (area of chronogram) of [PC 34:1+1K]⁺ using the weighing paper was at least 10 times as high as when using the filter paper.

Second, a weighing paper can maintain its folded shape better than any other paper substrate, and thus the shape of the paper cone tip is minimally distorted even after the addition of a solid sample and a spraying solvent.

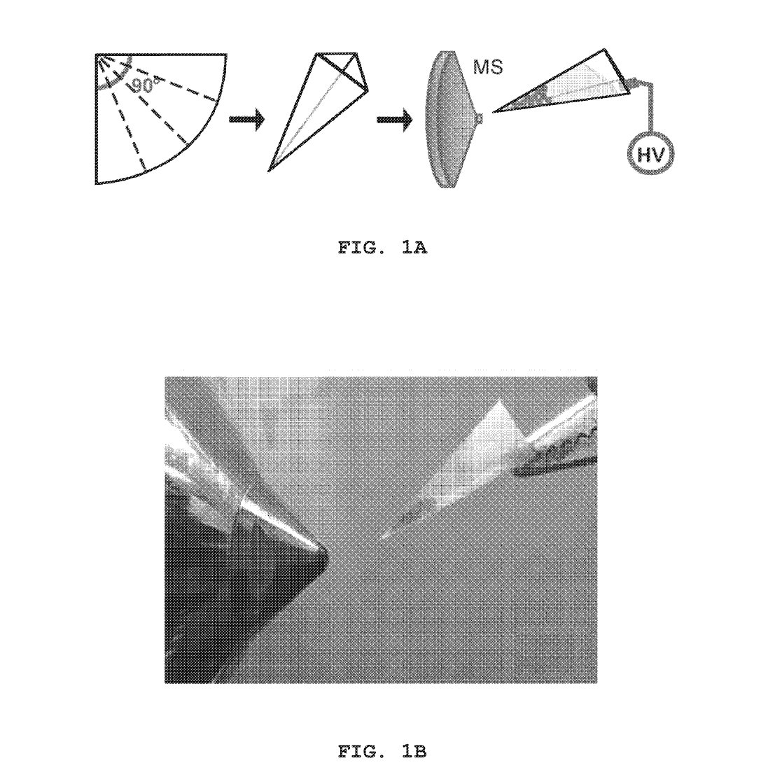

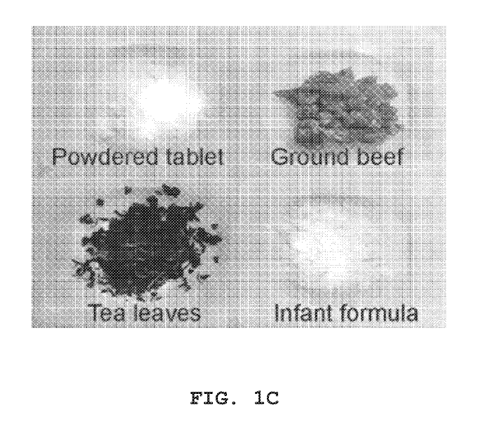

Third, the transparency of the weighing paper allows the amount of the sample that is loaded into the paper cone tip to be monitored, as illustrated in FIG. 1B.

Fourth, like chromatography or filter paper, a weighing paper does not show any substantial chemical background with the tested spraying solvents.

Lastly, a weighing paper is obviously a very affordable and easily accessible material.

In addition, the present invention addresses a PCSI MS method using the paper cone tip, comprising: preparing a triangular-pyramidal-shaped paper cone tip, placing a measuring sample in the paper cone tip and locating the paper cone tip in front of a mass spectrometer, and adding a spraying solvent to the paper cone tip and applying a voltage thereto.

Specifically, the PCSI MS method according to the present invention is described below.

First, a triangular-pyramidal-shaped paper cone tip with a vertex angle of 22.5° is prepared by folding a circular-sector-shaped paper (a quadrant with a radius of 1.5 cm) (FIG. 1A). The volume of the prepared paper cone tip is about 77 μL.

Second, the paper cone tip is partially filled with 1 milligram (mg) to 5 mg of a solid sample and then located in front of the MS inlet (FIGS. 1B and 1C).

Third, 20 μL to 50 μL of a spraying solvent is added to the tip, and then a high voltage (±3 kilovolts (kV) to 4 kV) is applied.

The paper cone tip according to the present invention may act as a sample container, an extraction chamber, a transport channel for extracted analytes, and an electrospray tip.

The spraying solvent is preferably an alcoholic solvent. Examples of the alcoholic solvent include, but are not limited to, methanol, ethanol, propanol, etc.

The spraying solvent may further include a salt such as ammonium acetate (NH₄OAc), in addition to the alcoholic solvent, in order to increase the extraction efficiency of a specific component.

Alternatively, a mixture of a solid sample and a spraying solvent in a slurry form may be introduced into the paper cone.

Useful for extraction, the measuring sample may include various solid materials including powdered drugs and food materials.

The voltage may be a high voltage of ±3 W to 4 kV.

A better understanding of the present invention may be obtained through the following examples which are set forth to illustrate, but are not to be construed to limit the present invention. In the following examples, specific compounds are used, but equal or similar effects may be exhibited even when equivalents thereof are used, as will be apparent to those skilled in the art.

### EXAMPLE 1

Various powdered drug tablets used in the present invention are summarized in Table 1 below. As ground eye round beef, infant formula, and green tea leaves, commercially available products were used. Low-nitrogen weighing paper having a thickness of 0.02 mm and a weight of 20 g/m² (Cat. No. KA22-13) was purchased from Korea Ace Scientific. Grade 1, grade 2, and glass microfiber filter paper and Grade 31 ET chromatography paper were purchased from Whatman (Maidstone, England).

Various solvents including methanol, ethanol, isopropanol, and hexane were purchased from Fisher Scientific (Fairlawn, N.J., USA).

TABLE 1

| | | | Amount of active | Amount of active |
|---|---|---|---|---|
| | Active | | ingredient per | ingredient per 1 mg |
| Drug | ingredient | Manufacturer | tablet | of tablet powder |
| Diazepam | Diazepam | Myung-In Pharm. | 2 mg | 12.4 μg |
| Stilnox | Zolpidem | Sanofi-Aventis | 10 mg | 64 μg |
| | tartrate | | | |
| Zantac 75 | Ranitidine | GlaxoSmithKline | 75 mg | 490 μg |
| Claritin | Loratadine | MSD | 10 mg | 99 μg |
| (Clarityne) | | | | |
| Norvasc | Amlodipine | Pfizer | 5 mg | 25 μg |
| Crestor | Rosuvastatin | AstraZeneca | 20 mg | 63 μg |
| | calcium | | | |
| Zesfan gold | Dimethicone | Chong Kun Dang | 50 mg | 74 μg |
| | DL-carnitine | Pharm. | (Dimethicone) | |
| Soksipan | Dimethicone | Green Cross | 25 mg | 52 μg |
| | Ursodeoxycholic | | (Dimethicone) | |
| | acid | | | |

2) Preparation of Paper Cone Spray Tip and Sample

A circular-sector-shaped paper (a quadrant with a radius of 1.5 cm) was folded into a triangular-pyramidal-shaped paper cone tip. The volume of the prepared paper cone tip was about 77 μL. For analysis of a drug tablet, the tablet was ground using a mortar and pestle to thus obtain a powder (1.0 mg to 5.0 mg), which was then loaded into the paper cone tip. The other solid samples (ground beef, green tea leaves, and infant formula) were directly placed in the paper cone tip without additional pretreatment.

### Test Example: PCSI MS

For PCSI MS, a paper cone tip containing a predetermined solid sample was fixed with an alligator clip connected to a high-voltage supply, and was then located in front of the MS inlet (FIG. 1B). The paper cone tip was oriented at an angle 30° from horizontal and located at a position spaced apart by about 5 mm from the MS inlet. Thereafter, 20 μL to 50 μL of a spraying solvent was added to the paper cone tip. High voltage was applied to the paper cone tip for 30 sec or 60 sec, after which the spraying solvent was added. Mass analysis was performed using a Thermo Finnigan LCQ Deca XP MAX quadrupole ion trap mass spectrometer (Thermo Scientific Inc., San Jose, Calif., USA). The voltage used for PCSI MS was ±3 W to 4 kV. The capillary tube voltage and temperature were 35 V and 2.50° C., respectively.

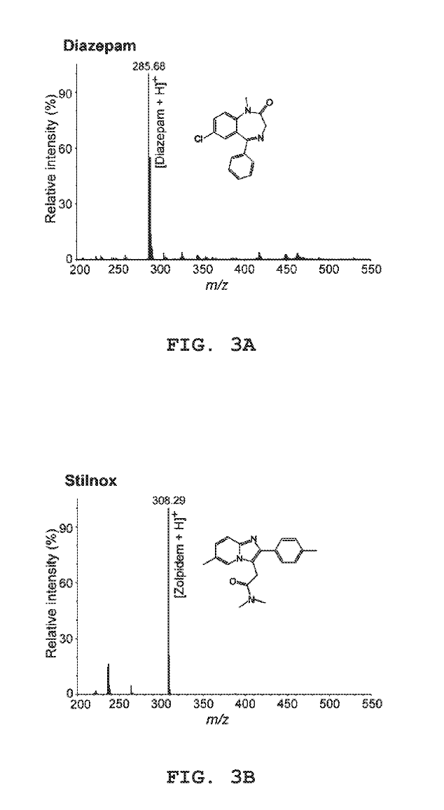

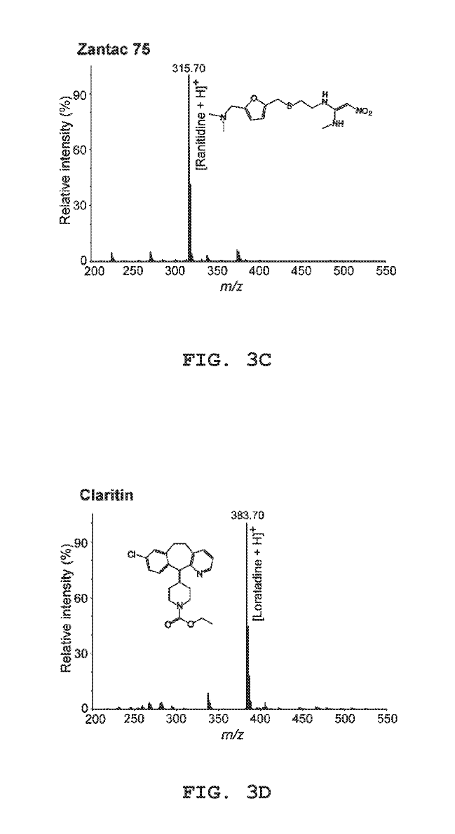

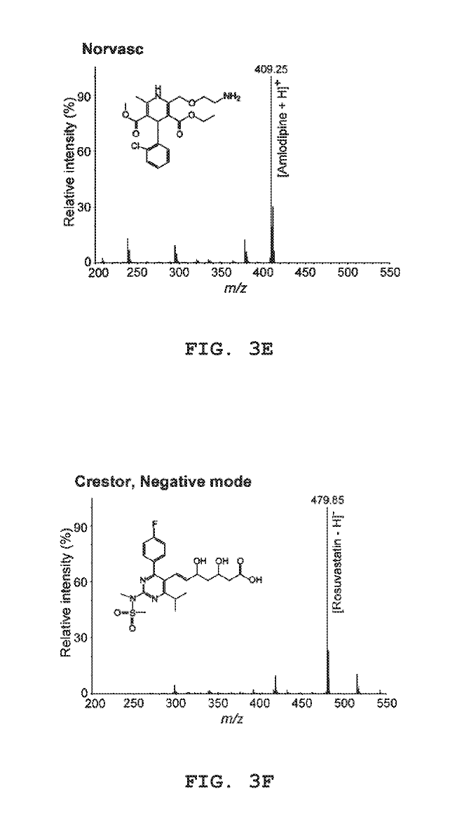

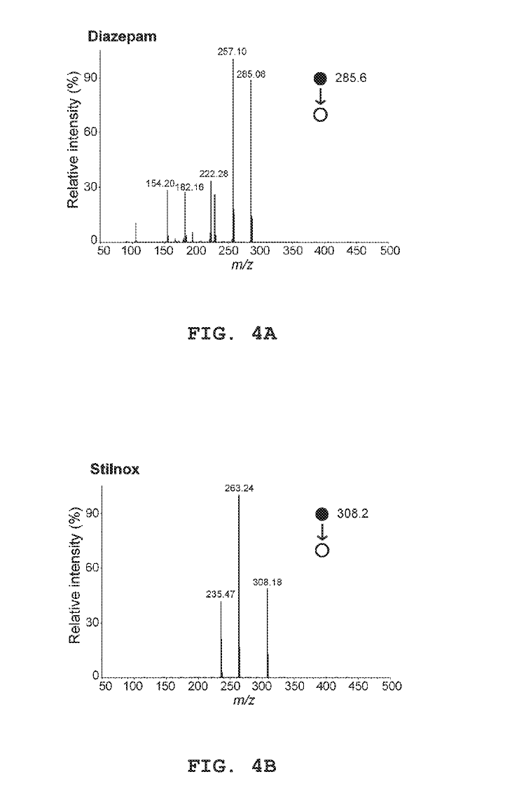

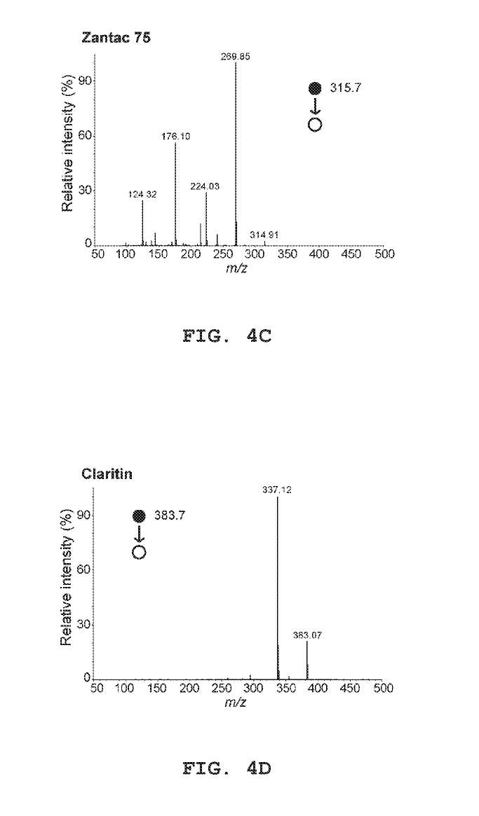

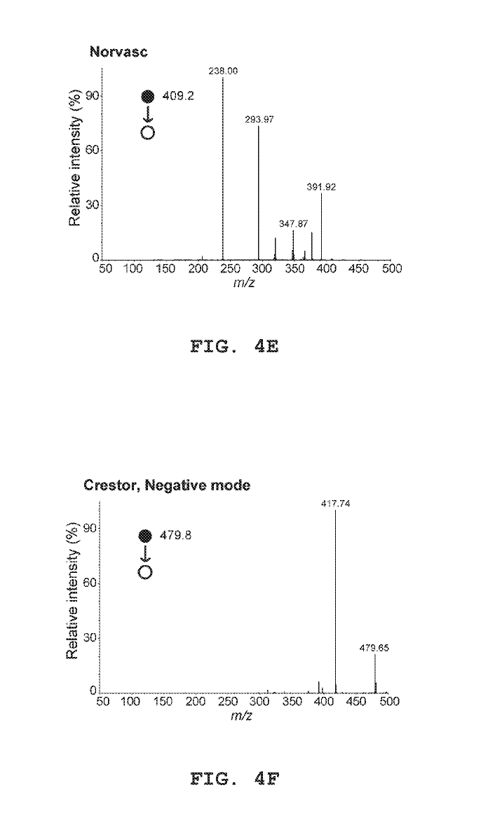

As illustrated in FIGS. 3A to 3F, the main active components were observed to have low chemical backgrounds when used with all the tested tablet drugs (the tandem mass spectra of the main active components are shown in FIGS. 4A to 4F).

When the amount of the powdered tablet sample loaded into the paper cone was 1 mg, the amount of the active component fell in the range of 12 micrograms (μg) to 490 μg. This is because main components typically constitute 1.2% to 49% of the total tablet mass (Table 1). In order to find the spraying solvents appropriate for powdered tablet analysis, all PSI-compatible solvents listed in previous studies were tested. From this investigation, all alcoholic spaying solvents were found to be preferable for use with most of the tested tablets in the present invention. Among the tested alcoholic solvents, ethanol showed the best performance in terms of signal stability, background level, and sensitivity.

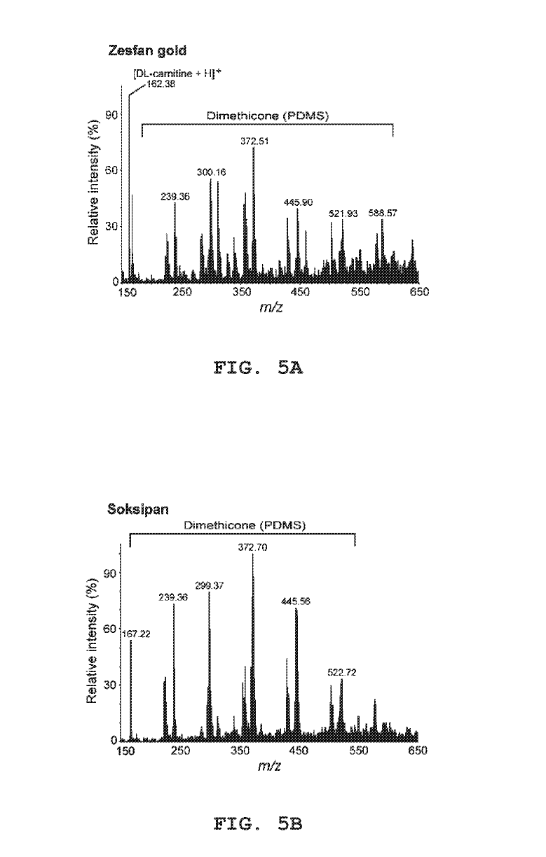

However, there was an exception in the analysis of digestive drugs containing polydimethylsiloxane (PDMS, also called dimethicone) (FIGS. 5A and 5B).

In this case, hexane worked the best in extracting and detecting PDMS from the powdered tablets. Also, a powdered sample need not be loaded in an amount of 10 mg or more into a paper cone, because partial wetting of the sample may occur. These results suggest that PCSI MS is well suited for the direct analysis of powdered solid samples through a simple procedure in which not even the dissolution of a powdered sample is required prior to PCSI MS. Therefore, PCSI MS is expected to be a useful method for the rapid identification of powdered or crushed pills and also for the forensic analysis of unknown powders.

In order to understand the extraction and ionization processes of PCSI MS, sequential extraction and analysis of zolpidem were performed from the same powdered Stilnox tablet sample (1.0 mg).

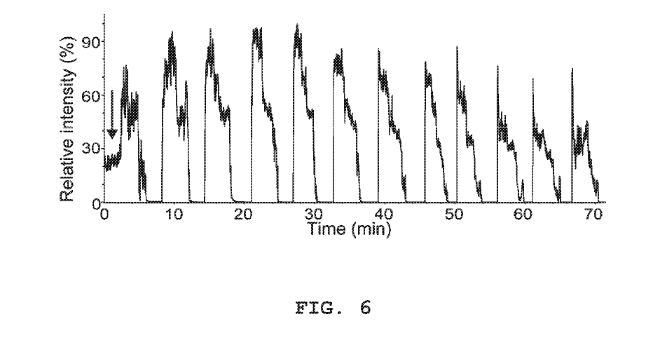

FIG. 6 illustrates the resulting extracted ion chronogram for the protonated ion of zolpidem. In the first extraction and analysis, a relatively low signal was observed in the beginning, as marked with an arrow. Then, the ion signal was increased and maintained from the middle of the first elution. This phenomenon is considered to be because a certain amount of time is required to wet a solid sample in the solid-liquid extraction process. The low intensity of the analyte profile in the beginning of PCSI could be eliminated simply by allowing the spraying solvent to interact with a solid sample for 30 seconds (sec) to 60 sec before applying a high voltage.

This wetting process before ionization was not difficult to achieve with experimental setup of the present invention because no significant loss of solvent was observed for a sufficiently long period of time (>120 sec) when an alcoholic spraying solvent was applied to a weighing paper cone tip without the application of high voltage. Alternatively, a mixture of a solid sample and a spraying solvent in a slurry form may be introduced into the paper cone. In the method of the present invention, however, it is difficult to control the sample-to-solvent ratio, and therefore the sample-to-sample signal reproducibility is poor.

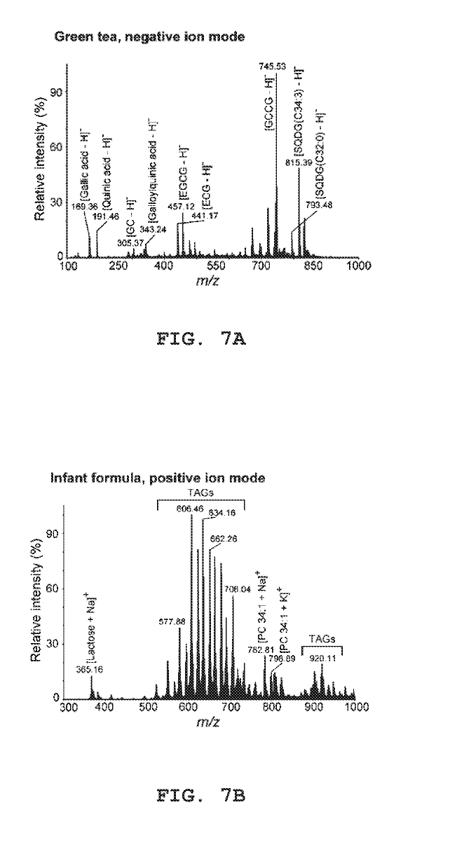

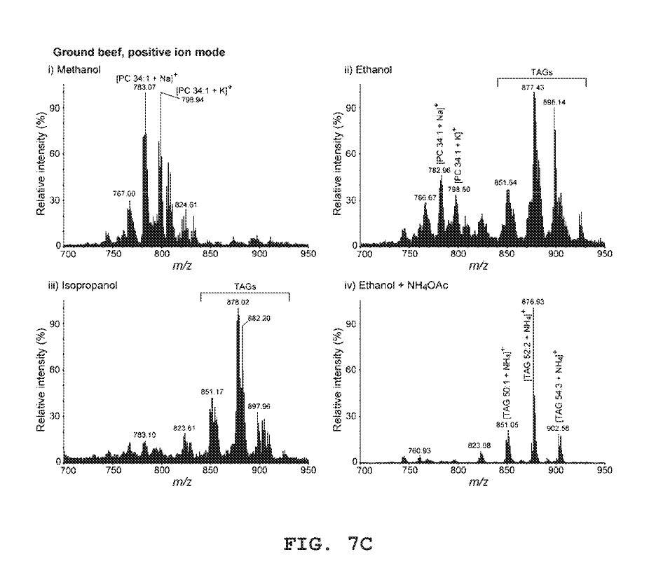

After the first extraction and detection, the second to the fourth extractions and analyses gave consistent profiles without the observation of a low signal plateau at the beginning of the elution. This is probably because the solid sample was already wetted in the first analysis and residual solvent might be present between the solid particles. After the fourth analysis, the magnitude of analyte ion signals gradually decreased. This is deemed to be because a small amount of analyte was left after multiple extractions. In the present invention, various raw and processed food materials such as green tea leaves, infant formula, and ground beef were subjected to PCSI MS. The results are shown in FIGS. 7A to 7C.

FIGS. 7A to 7C illustrate the PCSI mass spectra of various solid samples, including 1.0 mg of green tea leaves (FIG. 7A), 1.0 mg of infant formula (FIG. 7B), and 5.0 mg of ground beef (FIG. 7C). The spraying solvents used are methanol in FIGS. 7A, 7B, and 7C-i, ethanol in FIG. 7C-ii, isopropanol in FIG. 7C-iii, and ethanol with 5 mM ammonium acetate (NH₄OAc) in FIG. 7C-iv.

With reference to FIGS. 7A to 7C, for a green tea leaf sample, anion mode acquisition with methanol generated a profile containing major flavonoids (catechins), other phenolics, and sulfolipids (FIG. 7A). PCSI MS of infant formula with methanol mainly generated a profile of fats (FIG. 7B), while other components were not detected. Therefore, detection coverage expansion requires further optimization in the spraying solvent composition.

PCSI MS also instantly generated lipid fingerprints directly from a ground beef sample (FIG. 7C), but lipid profiles from PCSI MS varied significantly depending on the kind of spraying solvent. Methanol generated a phospholipid-focused profile, whereas ethanol and isopropanol resulted in more pronounced triacylglycerol (TAG) signals.

In this specific lipid fingerprinting example, the dielectric constant of the solvent may play a major role in the extraction and ionization efficiencies of lipids because the dielectric constants of these alcohols are notably different from each other (32.6 for methanol, 24.5 for ethanol, and 19.9 for isopropanol), whereas their dipole moments are very similar (within 1.6 and 1.7). Furthermore, selective lipid fingerprinting with reduced spectral complexity could be achieved by adding a suitable salt additive to the spraying solvent.

As illustrated in FIG. 7C-iv, a clean TAG profile was selectively obtained directly from a ground beef sample by adding an ammonium acetate salt, which is known to be an effective salt additive for TAG detection through electrospray ionization MS. These results suggest that PCSI MS can serve as a simple and rapid metabolite fingerprinting platform. Moreover, PCSI MS is expected to be used as a real-time monitoring tool for assessing the efficiency of solid-liquid extraction processes of interest.

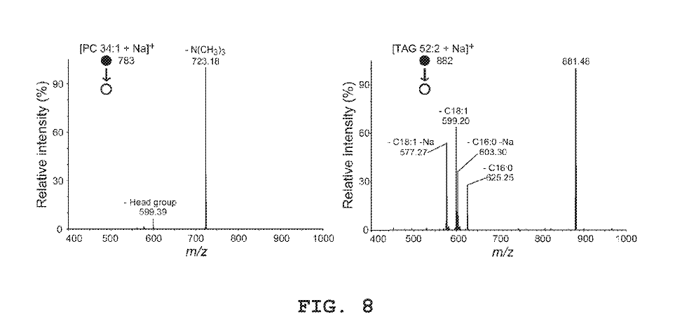

FIG. 8 illustrates the representative tandem mass spectra for [PC 34:1+Na]⁺ ions at m/z 783 and [TAG 52:2+Na]⁺ ions at m/z 832.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A paper cone tip, having a triangular-pyramidal shape with a vertex angle of 12.5° to 45°.

2. The paper cone tip of claim 1, wherein the paper cone tip is formed by folding a circular-sector-shaped paper into quarters.

3. The paper cone tip of claim 1, wherein the paper cone tip has a volume of 19.5 microliters (μL) to 303 μL.

4. The paper cone tip of claim 1, wherein the paper is a weighing paper.

5. The paper cone tip of claim 1, wherein the paper cone tip is transparent.

6. A paper cone spray ionization mass spectrometry method using a paper cone tip, comprising:
preparing the paper cone tip having a triangular-pyramidal shape with a vertex angle of 12.5° to 45°;
placing a measuring sample in the paper cone tip and locating the paper cone tip in front of a mass spectrometer; and
adding a spraying solvent to the paper cone tip and applying a voltage thereto.

7. The method of claim 6, wherein the spraying solvent is an alcoholic solvent.

8. The method of claim 6, wherein the paper cone tip serves as a sample container, an extraction chamber, a transport channel for an extracted analyte, and an electrospray tip.

9. The method of claim 6, wherein the measuring sample is a solid material including a powdered drug and a food material.

10. The method of claim 6, wherein the voltage is a high voltage of ±3 kilovolts (kV) to 4 kV.

11. The method of claim 6, wherein the paper cone tip comprises a weighing paper.

12. The method of claim 6, wherein the spraying solvent comprises a salt additive.

13. The method of claim 6, wherein the spraying solvent is a nonpolar solvent.

14. The method of claim 6, wherein the spraying solvent is ethanol.
